(19) United States
(12) Patent Application Publication
(10) Pub. No.: US 2020/0283031 A1
(43) Pub. Date: Sep. 10, 2020

(54) SUPPORT RAIL FOR A SPIRAL CONVEYOR

(71) Applicant: John Bean Technologies AB, Helsingborg (SE)

(72) Inventors: Bengt Anders Gerhard Bengtsson, Helsingborg (SE); Ulf Göran Gramby, Bjärred (SE); Per Martin Ström, Vinslöv (SE)

(73) Assignee: John Bean Technologies AB, Helsingborg (SE)

(21) Appl. No.: 16/293,258

(22) Filed: Mar. 5, 2019

(51) Int. Cl. B61B 15/00; B29C 55/20; B61B 3/00; B61B 5/00

(52) U.S. Cl. CPC B61B 15/00; B29C 55/20; E01B 25/00; B61B 5/00; B61B 3/00

(57) ABSTRACT

A longitudinally curved support rail (56) for supporting and moving a drive chain assembly (52) at the base of a spiral conveyor belt (34) to drive the bottom tier (30) of the spiral conveyor belt while being supported by the support rail. The support rail including an upright web section (80) and a support flange (78) cantilevered outwardly from the web section to provide a platform or shelf to support a chain drive assembly (52), thereon during travel of the chain drive assembly along the support rail.

### BACKGROUND

In a typical spiral conveyor system, a self-stacking belt is arranged in and travels in circular tiers from the bottom of the stack to the top and then perhaps in a second stack the belt travels from the top back down to the bottom of the stack. The bottom belt tier rests on and is driven by inner and outer drive chains which in turn are supported on roller chains that ride on a support rail. The support rail must carry the weight of the entire belt stack as well as the weight of the work product (often food) being carried by the spiral conveyor belt during a thermal processing operation which may involve either heating or cooling the food product.

Heretofore the inner and outer rails for supporting and carrying the roller chains were constructed in segments from multiple components, including a formed shelf structure composed of relatively thin gauge material shaped to provide a horizontal support surface for the roller chains. The formed shelf structure is secured to a backing structure presumably of sufficient structural integrity to enable the shelf structure to maintain its shape. The support rails thus configured are made in relatively short sections or segments that are connected together by brackets attached to the backing structure. Typically, at each joint the rail is connected to an upstanding post structure which supports the rail above the floor at the location of the spiral conveyor.

It has been difficult to achieve a consistently flat surface along the length of the support rail due to various reasons, including variations in the bending of the sheet material used to form the support shelf. Also, deformation may have occurred in welding the support shelf to the backing structure. Further, the rail structure is constructed from relatively short sections or segments which are bolted together. In addition, the sheet material used to form the shelf structure would not always be able to accommodate the high loads imposed on the shelf structure by a fully loaded spiral conveyor. As a result of the foregoing, bumps, depressions or other discontinuities often occur along the length of the support rail, and in particular along the length of the shelf structure. Such discontinuities, including “bumps,” result in spikes in the forces imposed on the drive chain, roller chain, and bottom belt tiers. This not only imposed high stress levels on these components, but also uneven loads are placed on the motors used to drive the inner and outer drive chains along the inner and outer support rails.

The present disclosure provides a support rail construction for a spiral conveyor belt system seeking to address the shortcomings of existing inner and outer support rail constructions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A longitudinally curved support rail supports a moving drive chain assembly at the base of a spiral conveyor belt, the drive chain assembly driving the bottom tier of the spiral conveyor belt while being supported by the support rail. The support rail includes an upright web section having a thickness as well as having a top edge and a bottom edge. The support rail also includes a support flange cantilevered laterally outwardly from the web section at an elevation along the height of the web section intermediate the top and bottom edges of the web section. The cantilevered support flange extends laterally from the web section to a location beyond the drive chain assembly to define a supporting ledge for receiving and supporting the drive chain assembly for travel along the support rail.

The support rail further includes an integral guide rim section which projects from the web section in a direction opposite to the direction that the support flange extends from the web section. The guide rim section is shaped to support a guide strip interposed between the guide rim section and drive link support columns of the drive chain assembly. The thickness of the web section of the support rail is reduced in the vicinity of the guide rim section.

The guide rim section projects laterally from the web section of the support rail a distance coinciding with the envelope of the web section of the support rail that has not been reduced in thickness.

The guide rim section is configured to fasten the guide strip to the guide rim section.

The top edge of the web section is slanted downwardly toward the drive chain assembly support flange.

The support ledge of the drive chain assembly support flange extends substantially horizontally from the web section of the support rail.

The drive chain assembly support flange defines an underside and a distal edge.

The drive chain assembly support flange defines an upwardly extending groove formed in the underside of the support flange near the distal edge of the support flange.

The drive chain assembly support flange defines an outer edge distal from the upright web section, with the outer edge extending downwardly from the upper support ledge a distance greater than the thickness of the adjacent section of the drive chain assembly support flange.

The support rail includes a catch trough extending along the support rail at a location beneath the outer edge of the support flange.

The support rail is formed in longitudinally extending curved sections.

The adjacent ends of the support rail curved sections are welded together to form a unitary, continuous curved rail without need of hardware members for assembling the support rail.

The support rail is formed in lengths of from about 2.6 to 3.9 meters in length. The support rail also includes a catch trough extending along the support rail at location beneath the drive chain assembly support flange.

The support rail is constructed so that the upright web section and the cantilevered support flange constitute a single unitary structure.

The support rail is formed in longitudinally extending sections with adjacent ends of the sections welded together to form a unitary, continuous support rail without need of hardware members for assembling the support rail into a continuous length.

The upright web section and the cantilevered support flange of the support rail are constructed as a single unitary extruded, roll formed and/or stamped structure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a spiral stacking conveyor belt system including a self-stacking conveyor belt and a drive system for driving the conveyor belt in accordance with embodiments of the present disclosure;

FIG. 2 is a top view of the spiral stacking conveyor belt system of FIG. 1 showing the inner and outer dive chains of the drive system;

FIG. 3 is an isometric view showing the inner and outer drive chains mounted on inner and outer support rails supported by upright stands;

FIG. 4 is a cross-sectional side view of the spiral stacking conveyor belt system of FIG. 1 showing the inner and outer drive chains of the drive system mounted on inner and outer support rails;

FIG. 5 is an isometric view of a section of the conveyor belt in the spiral stacking conveyor belt system of FIG. 1;

FIG. 6 is an isometric view of a length of roller chain of the belt drive system;

FIG. 7 is cross-sectional view of the support rails; and

FIG. 8 is an isometric view of a section of the support rail of FIGS. 4 and 7.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention or disclosure to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units that are the same or similar are not repeated so as to avoid redundancy in the present application.

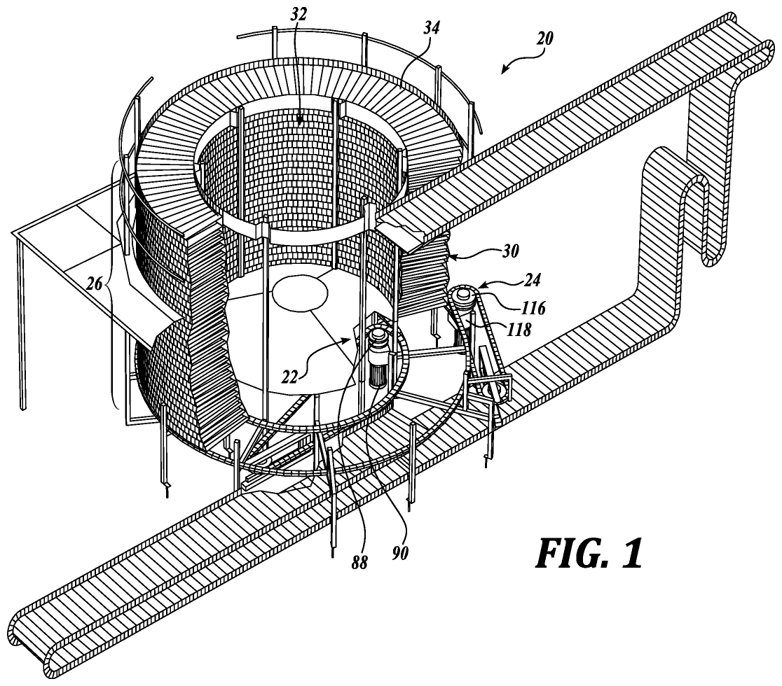

Referring to FIGS. 1-3, embodiments of the present disclosure are directed to spiral stacking conveyor belt systems 20 driven by inner and outer drive systems 22 and 24 and components thereof. The inner and outer drive systems 22 and 24 are generally manufactured from stainless steel components for corrosion resistance. In accordance with embodiments of the present disclosure, the system includes hardened stainless steel components to reduce the elongation of the drive chains over extended periods of use. In accordance with other embodiments of the present disclosure, the system includes hardened and/or dissimilar stainless steel components to reduce galling in the drive chains.

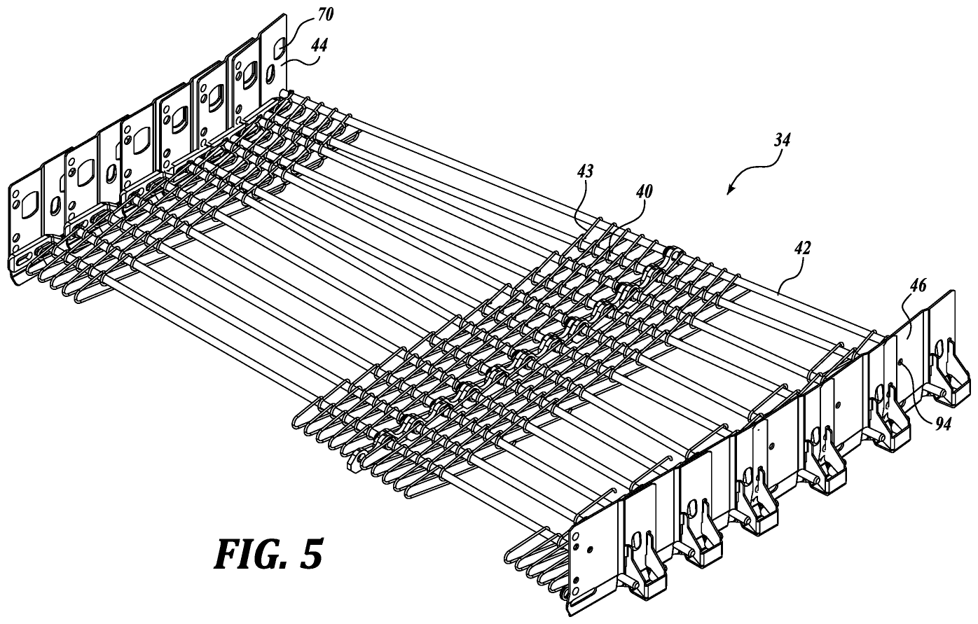

Suitable embodiments of spiral stacking conveyor belts are shown and described in U.S. Pat. No. 3,938,651, issued to Alfred et al., and U.S. Pat. No. 5,803,232, issued to Frodeberg, the disclosures of which are hereby expressly incorporated by reference. However, it should be appreciated that other suitable spiral belt assemblies are also within the scope of the present disclosure. Also, a spiral stacking conveyor belt 34 is shown in FIG. 5, as discussed below.

Referring to FIG. 1, when formed as a spiral stack 26, the pervious conveyor belt 34 is configured into a plurality of superimposed tiers 30 that are stacked on top of each other (i.e., known in the art as “self-stacking” conveyor belt). In that regard, each tier 30 of the stack 26 forms a pervious annulus, through which gaseous cooking or cooling medium may travel, whether for cooking or freezing systems. When formed in a spiral stack 26, the plurality of tiers 30 creates an inner cylindrical channel 32, through which the gaseous medium may also travel. Workpieces (such as food products) travel on the conveyor belt 34 and are affected (either cooked or frozen) by gaseous medium in the cooking or freezing chamber. Exemplary spiral stacks 26 may have any number of tiers 30, typically in the range of about 8 to about 25 tiers.

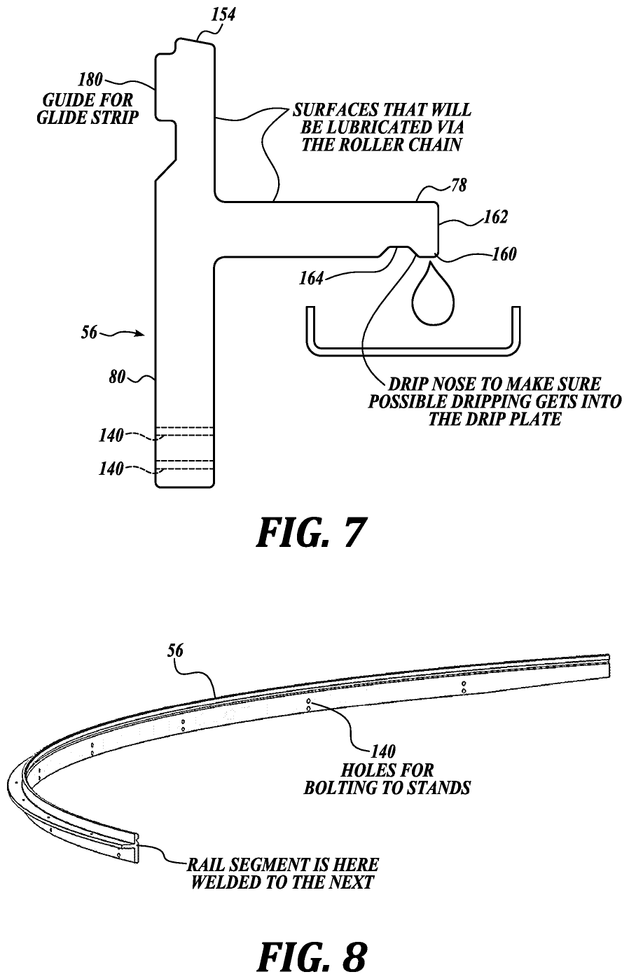

Referring to FIG. 5, as a non-limiting example, the conveyor belt 34 may be in the form of a pervious belt mesh 40 for conveying workpieces and formed by transverse rods 42 interconnected by intermediate wire links 43, as well as formed inner and outer links 44 and 46 positioned at the ends of the transverse rods 42. The inner and outer links 44 and 46 are configured to enable spiral stacking for the belt tiers 30, allowing collapsing of the inner links 44 when the belt 34 travels in a curved or circular path and for interconnection with the drive system (see FIG. 7). The inner and outer links 44 and 46 of the conveyor belt 34 interact with and are driven by the respective inner and outer drive systems 22 and 24.

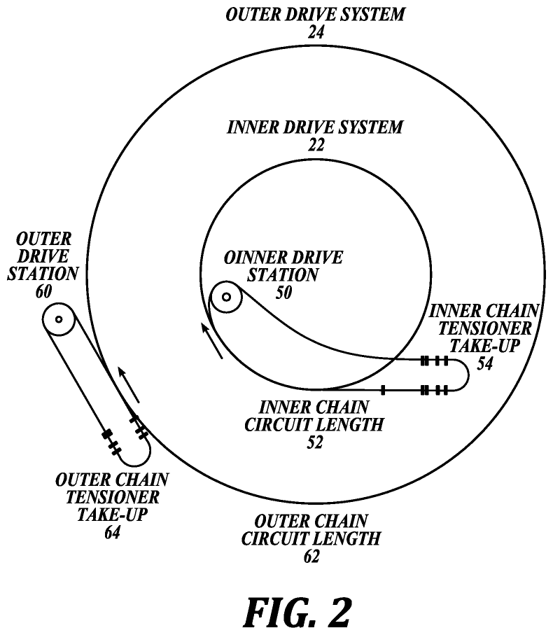

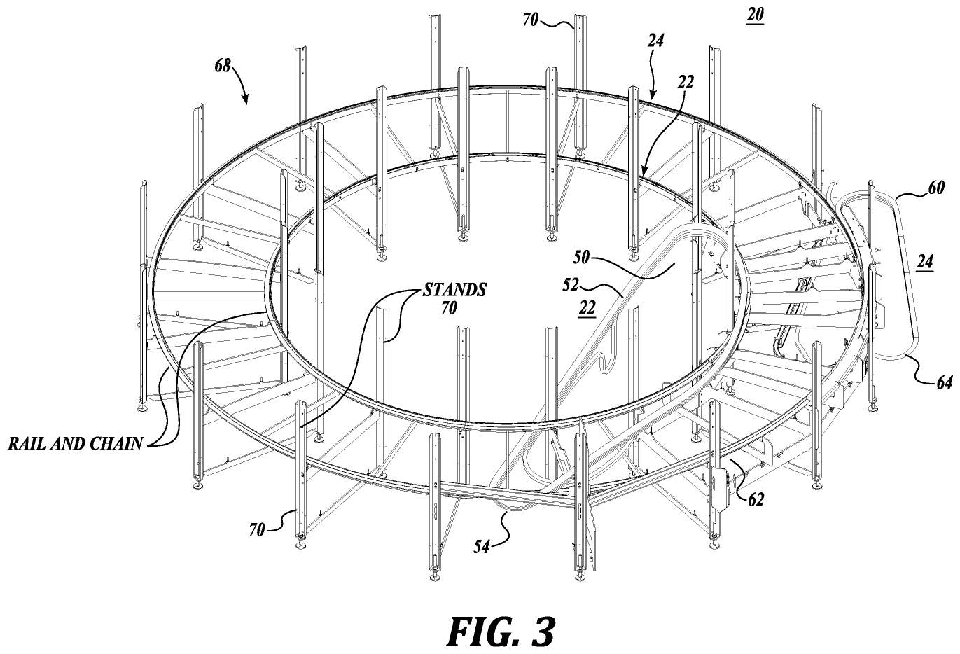

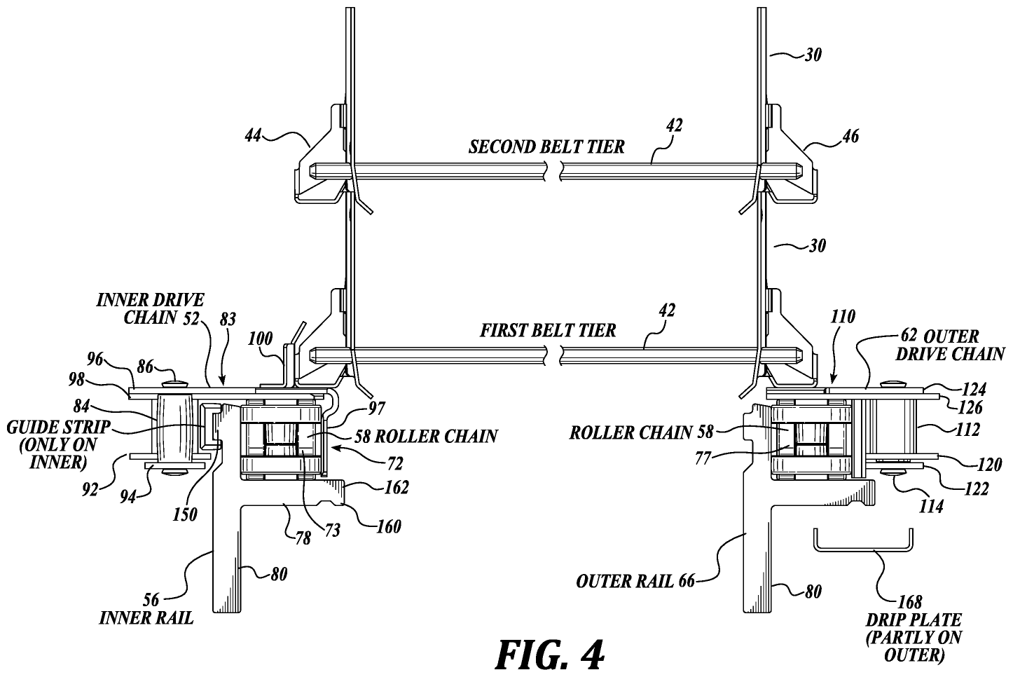

Referring to FIGS. 2 and 3, the conveyor belt 34 in the illustrated embodiment of FIG. 1 is driven by a drive system including inner and outer drive systems 22 and 24. The inner drive system 22 includes an inner drive station 50, an inner drive chain 52, and an inner chain tensioner take up 54. The outer drive system 24 includes an outer drive station 60, an outer drive chain 62, and an outer chain tensioner take up 64. Referring to FIG. 4, the inner drive chain 52 is supported by an inner rail 56 and the outer drive chain 62 is supported by an outer rail 66. The inner rail 56 and outer rail 66 are in turn supported by a support stand structure 68 composed of upright posts or stands 70 positioned about the circumference of the circular paths of the rails 56 and 66.

In the illustrated embodiment, the inner and outer drive chains 52 and 62 are roller chains, which are supported on the inner and outer support rails 56 and 66 by roller chains 58 for travel along the inner and outer rails 56 and 66, see FIG. 4. Thus, the roller chains 58 support movement of the inner and outer drive chains 52 and 62 along the inner and outer rails 56 and 66.

Describing the spiral conveyor support rail of the present disclosure in more detail, referring specifically to FIGS. 4-6, the roller chains 58 for the inner drive chain 52 and outer drive chain 62 are constructed from first roller sets 72 composed of rollers 73 that are axled together by axle 74 to rotate about a horizontal rotational axis 75. The rollers 73 of the first roller set ride on the upper surface of the support flange section 78 of inner rail 56.

The roller chain 58 also includes a second roller set 76 coupled to the first roller set 72. The second roller set 76 includes pairs of rollers 77 axled together by axles 77A to rotate about a vertical axis 77B so as to bear against the adjacent web portion 80 of the inner rail 56. The roller chains 58 are made up of sequential first roller sets 72 and second roller sets 76 extending along the lengths of the inner drive chain 52 and outer drive chain 62. As discussed more fully below, the roller chains 58 function to support the inner drive chain 52 on the inner rail and the outer drive chain 62 on the outer rail 66.

The rollers 56 of the first roller set 72 may be of various material compositions, such as a hardened metallic material capable of carrying the weight of not only the conveyor belt 34, but also the food product or other items being carried on the conveyor belt. One material from which the rollers 76 may be constructed is a high grade stainless steel.

The second roller set 76 functions to bear against the web portion 80 of the inner and outer rails 56 and 66 to minimize friction between the roller chains 58 as the inner and outer drive chains 52 and 62 travel in a curved or circular path along the inner and outer rails 56 and 66. Thus, the loading on the rollers of the second set is not extremely high, especially with respect to the load being carried by the roller 76. As such, the rollers of the second set may be composed of a low friction material, such as nylon.

Referring specifically to FIG. 4, the inner drive chain 52 supports and propels the lowest or first belt tier 30 for travel along the inner and outer rails 56 and 66. The inner drive chain 52 is composed of segments or sections 83 which are sequentially interconnected to each other end to end to define a continuous drive chain while enabling the sections to pivot sufficiently relative to each other to follow the curvature of the inner rail 56. A bottom plate 92 is attached to the lower ends of the two spacer columns 84 of each drive chain segment 83. Bottom link plates 94 are also interconnected to the spacer columns 84 of adjacent chain segments 83 to allow relative pivoting movement between adjacent chain segments 83 during travel in a curved ascending (or descending) path along the inner rail 56.

Correspondingly, a top plate 96 is attached to the upper ends of the spacer columns 84 of a chain segment 83. The top plate 96 extends horizontally laterally over the top of the inner rail 56 as well as the roller chain 58 and then extends downwardly at 97 to overlap the side of the roller chain 58 opposite to the inner rail web section 80 thereby capturing the roller chain 58 between the inner rail and the downward section 97 of the top plate 96. A top linking plate 98 interconnects the upper ends of the spacer columns 84 of adjacent chain segments 83 in the manner in which the lower link plates 94 function.

Continuing to refer specifically to FIG. 4, an upper wall 100 extends upwardly from the top plate 96 lengthwise of the top plate to engage with the inner links 44 of the conveyor belt 34 so as to pull the conveyor belt along with the inner drive chain 52 as the inner drive chain travels along the inner rail.

The outer drive chain 62 is constructed somewhat similarly to the inner drive chain 52. In this regard, the outer drive chain is constructed in chain segments 110 which are connected end to end to form the endless drive chain. Each chain segment 110 includes a pair of upright spacer columns 112 located near the end portions of the chain segments. A bottom plate 120 spans between the lower ends of the spacer columns 112 of each chain segment 110. A lower link plate 122 is interconnected between the lower ends of the spacer columns 112 of adjacent link segments 110 in the manner of link plates 94 discussed above.

A top plate 124 interconnects to upper ends of the spacer columns 112 to define the top sections of the chain segments 110. The top plate extends laterally inwardly towards the inner rail so as to bear against the rollers 77 of the roller chain 58 whereby the drive chain 62 is supported on the roller chain 58. A top link plate 126 interconnects the upper ends of adjacent spacer columns 112 of adjacent link segments 110 while allowing relative movement between the chain segments as the outer drive chain 62 travels in a curved ascending (or descending) path along the outer rail 66. A vertical abutment plate 128 extends downwardly from plate 126 inwardly of the spacer columns 112 to bear against the horizontal rollers 77 of the roller chain 58.

As shown in FIG. 4, the outer links 46 of the conveyor belt 34 bear downwardly against the upper surface of the top plate 124 to be supported by the top plate as the conveyor belt travels along the outer rail 66.

Next, describing in more detail the inner 56 and outer 66 rails. In this regard, the inner 56 and outer 66 rails may be of identical or near identical construction in terms of the cross-sectional profiles of the rails. Of course, the rails will differ in their curvature along their lengths due to the larger circumferential path of the outer rail 66 versus the inner rail 56, as depicted in FIG. 3. As such, the following description will reference inner rail 56 with the understanding that the description also applies to the outer rail 66.

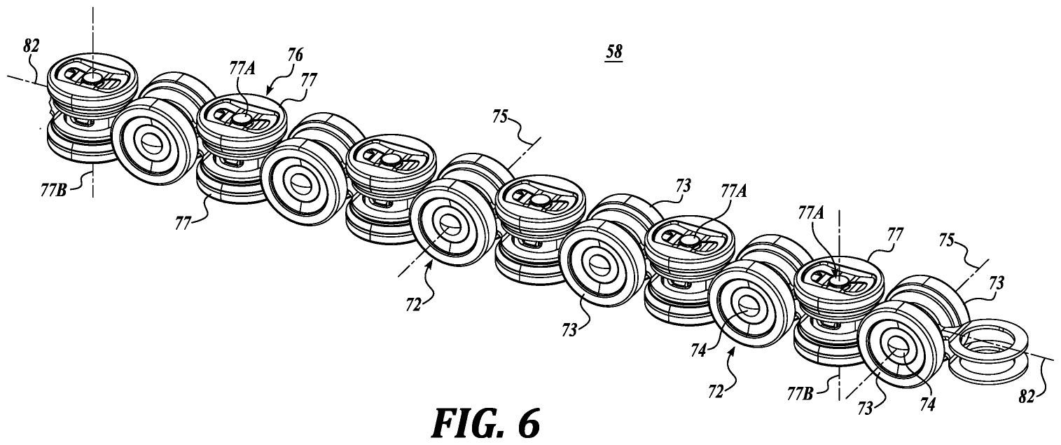

Referring specifically to FIGS. 4 and 6, the inner rail 56 is constructed with an upright web section 80 that is adapted to be mounted to posts 70 which extend upwardly from the floor to support the rails 56 and 66 above the floor. Through holes 140 are provided in the post web section to receive connectors such as bolts to securely fasten the rails 56 and 66 to the posts 70.

In basic form, the inner rail 56 also includes a support flange portion 78 that extends horizontally from the web portion 80 intermediate the ends of the web portion for receiving and supporting the inner roller chain 58 thereon. In this regard, the length of the flange portion 80 may extend beyond the width of the roller chain so as to provide secure support therefor. The flange portion 78 may be integrally formed with the web portion 80 of the rail 56.

A guide rim 150 is integrated into the web 80 near the upper end thereof and along the sides of the web opposite the flange 78. The guide rim 150 can be formed by reducing the thickness of the web beneath the guide rim as well as the thickness of the web above the guide rim so as to define the guide rim in the form of a laterally projecting rim section shaped to receive a guide strip structure 152 to extend over the guide rim as shown in FIG. 4. The guide strip structure includes a generally channel shaped outer configuration that bears against and closely engages over guide rim 150. The exterior of the guide strip structure bears against the spacer columns 84 of the inner drive chain 52. In this regard, the guide strip structure 152 can be composed of a self-lubricating material, a lubricant infused material, or other material that may be sacrificial with respect to the spacer columns 84, which bear there against. The guide strip structure 152 can be mounted to the guide rim 150 by any appropriate means.

It will be appreciated that the guide rim 150 for the guide strip structure 152 can be constructed otherwise than as shown in FIGS. 4 and 6. For example, the web portion 80 of the rail 56 may not be “undercut” beneath the guide rim 150, rather the web portion 80 can be of constant thickness or width along its height, with the guide rim projecting laterally from the web portion so as to form a wider or thicker section of the web portion at the location of the guide rim 150.

The upper end 154 of the web 80 may be sloped toward the support flange 78 so that any liquid that drips onto the top of the post will flow downwardly onto the support flange. As such, any accumulation of liquids on the top of the rail 56 will be minimized.

As shown in FIGS. 4 and 7, and as noted above, the flange portion 78 of rail 56 extends horizontally laterally from web portion 56 at an elevation intermediate the upper and lower ends of the web section. The thickness of the flange portion 78 may be the same or nearly the same as the cross-sectional thickness of the web portion 80. Of course, the cross-sectional thickness of flange portion 78 can be varied to accommodate the level of load required to be carried by the flange portion. Further, the flange portion 78 extends laterally a distance beyond the width of the roller chain 58 so as to support the roller chain even if the roller chain is not tight against and is spaced outwardly of the adjacent side edge of the rail web portion.

As shown in FIGS. 4 and 6, the outer edge of the underside of the support flange 78 is contoured to define a drip nose 160. Lubricants or other flowable substances on the top surface of the support flange will flow down the outer edge 162 of the support flange and then to beneath the support flange to the location of the drip nose 160. Due to an undercut 164 made on the bottom edge of the outer portion of the support flange 78, the drip nose portion 160 projects downwardly further than the adjacent inward portion of the support flange underside. As a consequence, liquids that collect at the drip nose will fall downwardly from the drip nose. A drip plate, drip pan, or catch trough 168 is positioned below the drip nose 160 to collect the lubricants or any other flowable liquids or substances that fall from the drip nose. The lubricants originate from the roller chain 58 which is lubricated for wear resistance. The drip pan 168 will catch such lubricants so as not to fall downwardly on the food items or other work product being transported by the spiral stack conveyor belt system 20.

As illustrated in FIG. 7, the profile of the inner rail 56 facilitates being able to form the inner rail in relatively long sections that can be curved as desired, for example, into the diameter of the inner rail, as shown in FIG. 3. The sections of the inner rail 56 can be welded end to end so as to result in a continuous integrated structure of high structural integrity. Current conveyor belt support rails are typically made in relatively short sections that are bolted together at each of the posts 70. This results in a discontinuous rail structure. The surface of the rail structure on which the roller chain rides typically is uneven, especially at the connection locations between rail sections at the support posts 70. If there is any “bump” or depression in the rail, a spike in the forces on the drive chain and the roller chain occurs at such location, as well as in the bottom belt tiers. Moreover, if the support rails are constructed from short segments, numerous unhygienic bolted joints occur which need to be cleaned thus causing down time of the conveyor belt system 20.

It will be appreciated that by constructing the rail 56 from a singular integrated structure formed, for example, by extruding or roll forming (or stamping), tight dimensional tolerances for the rail structures 56 and 66 can be achieved. This is difficult to accomplish if the rail structure is composed of several components that are welded or otherwise assembled together to form the rail, in the manner of the current art. Moreover, the cross-sectional shape of the present inner rail 56 and outer rail 66 results in high structural integrity of the rail as well as high stiffness. As a result, deflections in the rails 56 and 66 during operation of the conveyor belt system 20 is minimized. Further, due to the tight tolerances achieved during the extruding or roll forming of the rail structure, it is possible to weld sections of the rail structure end to end so as to achieve a substantially seamless, unitary structure along the entire length of the rails 56 and 66. Heretofore, this has not been achieved in the support rails for spiral stacking conveyor belt systems.

As non-limiting examples, the overall height of the rails 56 and 66 can be from about 3.0 to 4.0 inches and the support flange can extend laterally from about 1.5 to 2.25 inches from the web 80. Also, the web 80 can have a thickness of about 0.425 to 0.525 inches as shown in FIG. 7. Further, the thickness of the flange can be about 0.375 to 0.475 inches. The rails 56 and 66 can be formed on sections of lengths of about 8.5 feet (2.6 meters) to about 12.8 feet (3.9 meters). Of course there dimensions can vary depending on various factors, such as the load that the rails need to support and the size of the inner and outer drive chains supported by the rails 56 and 66.

While illustrative embodiments have been illustrated and described, it will be appreciated that various changes can be made therein without departing from the spirit and scope of the invention.

1. A longitudinally curved support rail for supporting a moving drive chain assembly at the base of a spiral conveyor belt, the drive chain assembly driving the bottom tier of the spiral conveyor belt while being supported by the support rail, the support rail comprising:
(a) an upright web section having a thickness, a top edge and a bottom edge; and
(b) a drive chain assembly support flange cantilevered laterally outwardly from the web section at an elevation along the height of the web section intermediate the top and bottom edges of the web section, the cantilevered support flange extending laterally from the web section to a location beyond the drive chain assembly to define a support ledge for receiving and supporting the drive chain assembly for travel along the support rail.

2. The support rail of claim 1, further comprising an integral guide rim section projecting from the web section in a direction opposite to the direction that the support flange extends from the web section, the guide rim section shaped to support a guide strip interposed between the guide rim section and drive link spacer columns of the drive chain assembly.

3. The support rail of claim 2, wherein the thickness of the web section of the support rail is reduced in the vicinity of the guide rim section.

4. The support rail of claim 3, wherein the guide rim section projects laterally from the web section of the support rail a distance coinciding with the envelope of the web section of the support rail that has not been reduced in thickness.

5. The support rail of claim 1, wherein the guide rim section is configured to fasten the guide strip to the guide rim section.

6. The support rail of claim 1, wherein the top edge of the web section is slanted toward the drive chain assembly support flange.

7. The support rail of claim 1, wherein the support ledge of drive chain assembly support flange extends substantially horizontally from the web portion of the support rail.

8. The support rail of claim 1:
wherein the drive chain assembly support flange defining the underside and a distal edge, and
further comprising an upwardly extended groove formed in the underside of the drive chain assembly support flange near the distal edge of the chain support flange.

9. The support rail of claim 1, wherein the drive chain assembly support flange defining the outer edge distal from the upright web section, said outer edge extending downwardly from the upper support ledge a distance greater than the thickness of the adjacent section of the drive chain assembly support flange.

10. The support rail of claim 9, further comprising a catch trough extending along the support rail at a location beneath the outer edge of the support flange.

11. The support rail of claim 1, wherein the support rail is formed in longitudinally extending, curved sections with adjacent ends of the curved sections welded together to form a unitary, continuous, curved support rail without hardware members for assembling the support rail.

12. The support rail of claim 11, wherein the section of the support rail is formed in lengths of from 2.6 to 3.9 meters in length.

13. The support rail of claim 1, further comprising a catch trough extending along the support rail at a location beneath the drive chain assembly support flange.

14. The support rail of claim 1, wherein the upright web section and the cantilevered support flange composed of a unity structure.

15. The support rail of claim 14, wherein the support rail is formed in longitudinally extending sections with adjacent ends of the sections welded together to form a unitary, continuous support rail without hardware members for assembling the support rail in a continuous length.

16. The support rail of claim 1, wherein the upright web section and the cantilevered support flange composed of a singular, unitary extruded, roll formed and/or stamped structure.
